(19) United States
(12) Patent Application Publication
(10) Pub. No.: US 2009/0180278 A1
(43) Pub. Date: Jul. 16, 2009

(54) Safety helmet with solar power-operated headlight and warning signal light

(76) Inventors: Chun Kung Cheng, Banqiao City (TW); Wen Tsung Kuo, Sanchong City (TW); Chang Fong Liou, Fengyuan City (TW)

Correspondence Address: PRO-TECHTOR INTERNATIONAL SERVICES, 20775 NORADA CT., SARATOGA, CA, 95070, US

(21) Appl. No.: 12/008,497

(22) Filed: Jan. 11, 2008

(51) Int. Cl. F21V 33/00

(52) U.S. Cl. 362/106

(57) ABSTRACT

A safety helmet includes a helmet body, a solar panel on the surface of the helmet body, a headlight at the front side of the helmet body, a warning signal light at the rear side of the helmet body, a control circuit and a rechargeable battery on the inside of the helmet body, and a switch on the outside of the helmet body. When the switch is off, electric energy generated by the solar panel is stored in the rechargeable battery subject to the control of the control circuit; when the switch is on, the loop of the control circuit and the headlight and the warning signal light is closed, causing the headlight to emit light for illumination and the warning signal light to flash for giving a visual warning signal to vehicles from behind to assure safety when riding a bicycle or working at night.

### BACKGROUND OF THE INVENTION

1. Field of the Invention

The present invention relates to safety helmets and more particularly, to a safety helmet with a headlight and a warning signal light using solar power as a power source.

2. Description of the Related Art

Riding a bicycle is a kind of recreational activity that is in conformity with the concept of environmental protection while exercising the body physically. However, there are many persons injured in bicycle accidents. For example, according to an official statistics report, there are 3,700 persons injured in bicycle accidents yearly in Taiwan, and the dead rate is about 3%˜5%. The statistics report also shows that at least 10 persons are injured in bicycle accidents daily, and one is dead per every two days. According to investigation, all the bicycle accident victims had a fatal head or neck injury and neither one of them worn a helmet. Therefore, wearing a safety helmet while riding a bicycle is the only way to effectively protect the head and neck.

On the other hand, because of poor vision at night, it is dangerous to ride a bicycle at night. When riding a bicycle at night, a headlight and a warning signal light are necessary. Unlike a motorcycle or motorcar that has the headlight and warning signal light as its standard equipment, the headlight and the warning signal light are optional equipment for bicycle. For a bicycle, the headlight and the warning signal light are to be secured to the handlebar and the seat post by fastening means for illumination and signal purposes when riding at night.

During a bicycle riding activity, the safety helmet, the headlight and the warning signal light are the three important devices required. However, they are separate and discrete members not well arranged together. According to conventional techniques, the headlight and the warning signal light are fastened to the helmet by means of hook and loop materials (Velcro tapes), an elastic headband, or a specially designed fixture. There are commercial safety helmets equipped with a LED light at the back side for giving a visual warning signal. These safety helmets commonly use a battery to provide the necessary working voltage for the LED light. The use of a battery costs a lot. Further, a waste battery must be properly disposed off to prevent heavy metal pollution. Therefore, using a safety helmet having a battery-operated light makes neither economic nor environmental sense.

Therefore, it is desirable to provide a safety helmet for bicycle that is equipped with a solar power-operated headlight and warning signal light.

### SUMMARY OF THE INVENTION

The present invention has been accomplished under the circumstances in view.

It is therefore the main object of the present invention to provide a safety helmet with a headlight and a warning signal light using solar power as a power source that allows the electric energy generated by a solar panel at the helmet body be stored in a rechargeable battery during the day, and enables the rechargeable battery to provide power to the headlight at the front side of the helmet body and the warning signal light at the back side of the helmet body, assuring safety when riding a bicycle or working at night.

To achieve this and other objects of the present invention, the safety helmet comprises a helmet body, a solar panel mounted on the surface of the helmet body for converting solar energy into electric energy, a control circuit electrically connected with the output terminal of the solar panel, a rechargeable battery for storing electric energy inputted from the solar panel through the control circuit, light emitting means mounted on the helmet body and functioning subject to the control of the control circuit, and a switch mounted on the helmet body for closing/opening the loop of the control circuit and the light emitting means.

The aforesaid light emitting means includes a headlight mounted on the front side of the helmet body, and at least one warning signal light mounted on the rear side of the helmet body.

The aforesaid at least one warning signal light includes a first warning signal light mounted on the left rear side of the helmet body, and a second warning signal light mounted on the right rear side of the helmet body.

The aforesaid at least one warning signal light and headlight are connected in parallel, and the at least one warning signal light uses at least two different colors of light emitting diodes.

The aforesaid control circuit controls the headlight to perform an illumination mode and the at least one warning signal light to flash subject to the switching of the switch.

The aforesaid rechargeable battery is selected from one of Li-battery, nickel-metal hydride battery, nickel-cadmium battery, and power capacitor.

### BRIEF DESCRIPTION OF THE DRAWINGS

FIG. 1 is elevational view of a safety helmet in accordance with the present invention.

FIG. 2 is a front view of the safety helmet shown in FIG. 1.

FIG. 3 is a rear side view of the safety helmet shown in FIG. 1.

FIG. 4 is a right side view of the safety helmet shown in FIG. 1.

FIG. 5 is a circuit block diagram of the present invention.

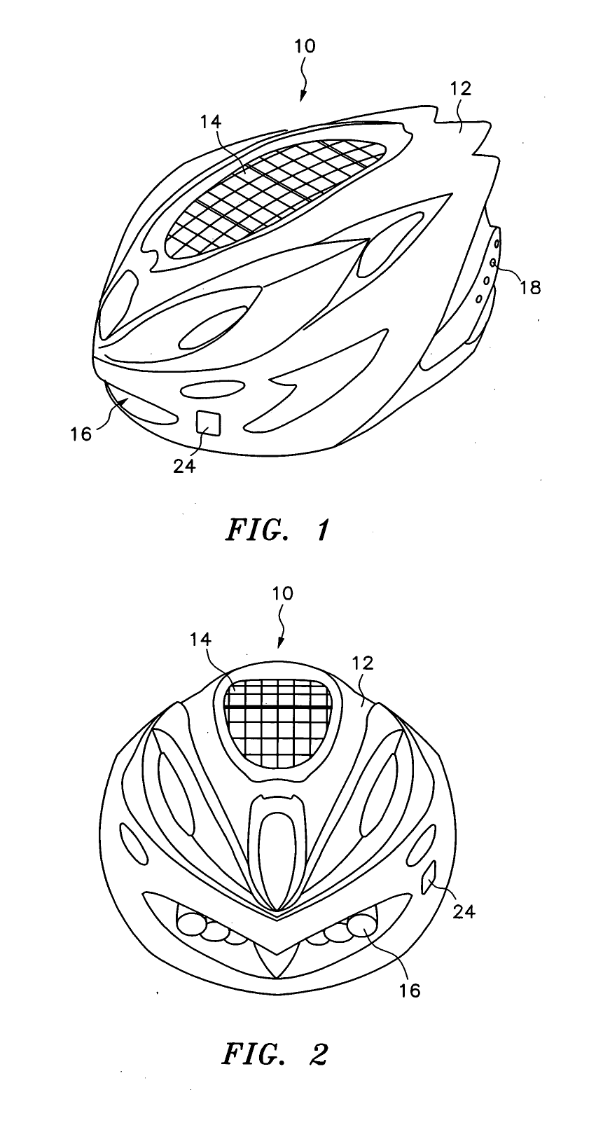

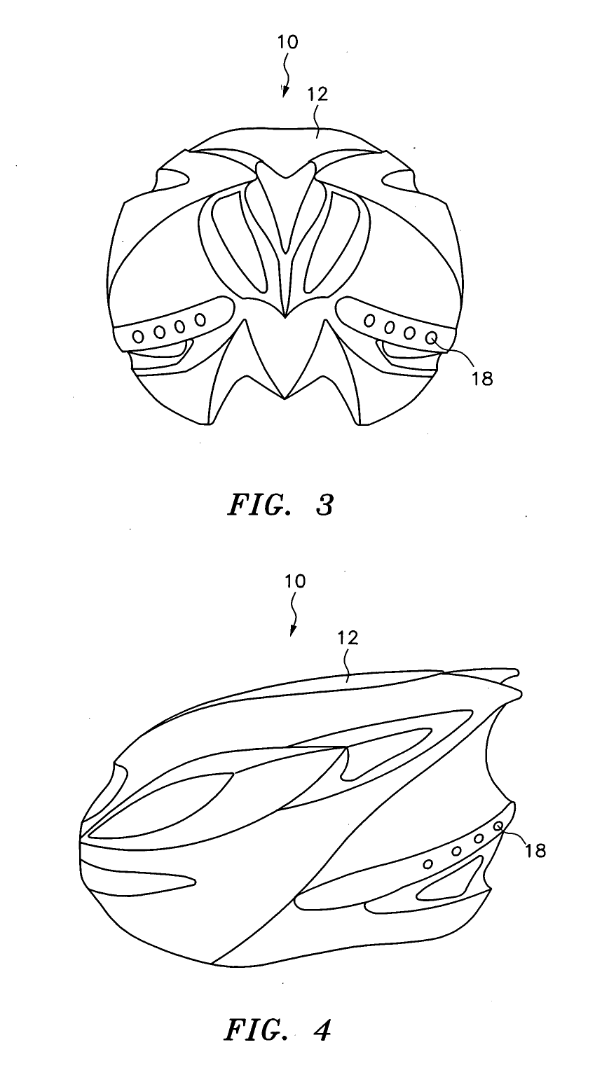

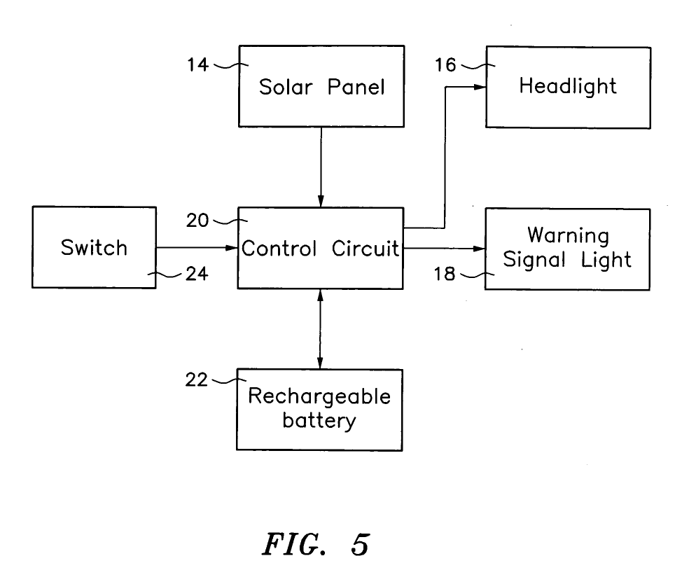

### DETAILED DESCRIPTION OF THE PREFERRED EMBODIMENT

Referring to FIGS. 1˜5, a safety helmet 10 in accordance with the present invention is shown comprising a helmet body 12, a solar panel 14 mounted on the surface of the helmet body 12 at a suitable location, for example, top side, a headlight 16 mounted on the front side of the helmet body 12, a warning signal light 18 mounted on the rear side of the helmet body 12, a control circuit 20 and a rechargeable battery 22 mounted inside the helmet body 12, and a switch 24 electrically connected with the control circuit and the rechargeable battery 22 and exposed to the outside of the helmet body 12. By means of the aforesaid component parts, the safety helmet 10 uses solar energy as the power source, and provides illumination and visual signaling functions. When the user is riding a bicycle at night, the safety helmet 10 gives protection and safe during bicycle riding.

The solar panel 14 is mounted on the surface of the helmet body 12 for collecting photo energy and converting photo energy into electric energy for illumination and signaling purpose.

The control circuit 20 is electrically connected with the output terminal of the solar panel 14 to control battery charging and discharging and on/off of the headlight 16 and the warning signal light 18.

The rechargeable battery 22 is electrically connected with the control circuit 20. Subject to the control of the control circuit 20, the electric energy generated by the solar panel 14 is stored in the rechargeable battery 22 for discharge when there is no sunlight. The rechargeable battery 22 can be a Li-ion battery, nickel-metal hydride battery, nickel-cadmium battery, or power capacitor.

The headlight 16 receives on/off control signal from the control circuit 20, and functions subject to the on/off control signal for frontward illumination. The headlight 16 can be formed of a predetermined number of LEDs (light emitting diodes) for high brightness illumination, assuring safety for night riding.

The warning signal light 18 is electrically connected in parallel to the headlight 16, and adapted to receive on/off control signal from the control circuit 20 and to function with the headlight 16 subject to the on/off control signal. In one preferred embodiment of the present invention, the warning signal light 18 is comprised of two or two sets of light emitting elements, for example, LEDs that are symmetrically arranged on the back side of the helmet body 12 and spaced from each other at a distance, i.e., one on the right rear side and the other on the left rear side, thereby providing a wide-angle signaling effect. Preferably, the warning signal light 18 is formed of two or more than two colors of LEDs, for example, red LED and yellow LED. Cross flashing of the different colors of LEDs of the warning signal light 18 provides an outstanding visual warning signal to vehicles from behind, assuring riding safety.

The switch 24 is electrically connected with the control circuit 20 and exposed to the outside of the helmet body 12 for operation by the user to switch on/off the loop formed of the control circuit 20, the headlight 16 and the warning signal light 18.

Preferably, the control circuit 20 controls the headlight 16 and the warning signal light 18 selectively to perform different lighting and flashing modes subject to the on/off control of the switch 24.

When illumination is not necessary during the day, the switch 24 is switched to Off position to cut off the aforesaid loop. At this time, the electric energy generated by the solar panel 14 is stored in the rechargeable battery 22 subject to the control of the control circuit 20. When illumination is necessary at night, the switch 24 is switched to On position to close the aforesaid loop, thereby causing the headlight 16 to emit light for frontward illumination and the warning signal light 18 to flash for giving a visual warning signal to vehicles from behind, assuring bicycle riding safety at night.

However, it is to be understood that the safety helmet of the invention is not limited to the purpose for bicycle riding, and the invention is applicable to any of a variety of other forms of helmets, such as industrial safety helmets and sports helmets.

According to the present invention, the headlight and the warning signal light are built in the safety helmet, and therefore the safety helmet gives protection and safety during bicycle riding.

Further, the safety helmet of the present invention consumes solar power as the power source for the headlight and the warning signal light. Solar power is a pure, safe and free natural resource, and its supply is unlimited and its utilization is endless. Therefore, utilization of solar power is economic and environmentally protective.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A safety helmet comprising:
a helmet body;
a solar panel mounted on the surface of said helmet body and adapted to convert solar energy into electric energy;
a control circuit electrically coupled to an output terminal of said solar panel;
a rechargeable battery for storing electric energy outputted from said solar panel subject to the control of said control circuit;
light emitting means installed in said helmet body and adapted to receive a control signal from said control circuit and to function subject to the control signal received; and
a switch mounted on said helmet body and adapted to control on/off of the loop of said control circuit and said light emitting means.

2. The safety helmet as claimed in claim 1, wherein said light emitting means comprises a headlight mounted on a front side of said helmet body.

3. The safety helmet as claimed in claim 1, wherein said light emitting means comprises at least one warning signal light mounted on a rear side of said helmet body.

4. The safety helmet as claimed in claim 1, wherein said light emitting means comprises a headlight mounted on a front side of said helmet body, and at least one warning signal light mounted on a rear side of said helmet body.

5. The safety helmet as claimed in claim 4, wherein said at least one warning signal light and said headlight are electrically connected in parallel.

6. The safety helmet as claimed in claim 4, wherein said at least one warning signal light comprises a first warning signal light mounted on a left rear side of said helmet body and a second warning signal light mounted on a right rear side of said helmet body.

7. The safety helmet as claimed in claim 4, wherein said at least one warning signal light comprises a plurality of light emitting diodes, said light emitting diodes having different colors.

8. The safety helmet as claimed in claim 4, wherein said control circuit controls said at least one warning signal light to flash subject to the switching of said switch.

9. The safety helmet as claimed in claim 2, wherein said control circuit controls said headlight to perform an illumination mode subject to the switching of said switch.

10. The safety helmet as claimed in claim 1, wherein said rechargeable battery is selected from one of Li-battery, nickel-metal hydride battery, nickel-cadmium battery, and power capacitor.
